(19) United States
(12) Patent Application Publication
(10) Pub. No.: US 2012/0026069 A1
(43) Pub. Date: Feb. 2, 2012

(54) MOBILE TERMINAL DEVICE, AND CONTROL PROGRAM AND MULTIPLE DISPLAY SCREEN CONTROL METHOD THEREFOR

(76) Inventor: YASUNARI OHSAKI, Tokyo (JP)

(21) Appl. No.: 13/262,052

(22) PCT Filed: Mar. 31, 2010
(86) PCT No.: PCT/JP2010/055819

§ 371 Date: Sep. 29, 2011

(30) Foreign Application Priority Data
Mar. 31, 2009 (JP) 2009-086635

(51) Int. Cl. G09G 5/00

(52) U.S. Cl. 345/1.2

(57) ABSTRACT

A mobile terminal device comprises: a first main display unit that has a first display screen; a second main display unit that has a second display screen which can display equivalent to the first display screen, the second main display unit being connected so as to be capable of being juxtaposed to the first main display unit; a display state detection unit that detects whether or not both the first display screen and the second display screen are in a state where simultaneous display is possible; an operation target screen selection unit that executes a function to select, among the first display screen and the second display screen, a screen that is a target for operation; and an operation target screen switching icon display unit that executes a function to display an operation target screen switching icon at least on the screen selected by the operation target screen selection unit, when the display state detection unit detects that both the first display screen and the second display screen are in a state in which display is possible; wherein the operation target screen selection unit switches an operation target screen when the operation target screen switching icon is selected.

### TECHNICAL FIELD

### Description of Related Application

This application claims the benefit of Japanese Patent Application No. 2009-086635, filed on Mar. 31, 2009, which is hereby incorporated by reference herein in its entirety. The present invention relates to a mobile terminal device such as a mobile telephone or the like, and a control program and multiple display screen control method therefor. In particular, the invention relates to a mobile terminal device in which multiple screens can display simultaneously.

### BACKGROUND

In conventional general mobile terminal devices, various types of application software such as a mailer, a browser, or the like, are displayed in a main display screen of a display unit. A user executes a prescribed operation while browsing a screen displayed in a display region by using an operation unit. However, in a case where during a task it is necessary to perform a task using another application, it has been necessary to temporarily end the application currently in operation and then newly start another application.

In order to solve this problem, Patent Document 1 proposes a mobile terminal device that enables switching of a main display screen, by selecting icons corresponding to respective applications generated on a sub-display screen.

Furthermore, Patent Document 2 and Patent Document 3 disclose a mobile terminal device provided with a second main display unit having a second main display screen connected by a hinge unit or by a slide system with a main display unit, wherein two screens are displayed at the same time. According to these inventions, a user can carry out an operation while browsing two screens at the same time.

### PRIOR ART DOCUMENT

### Patent Document

[Patent Document 1] Japanese Patent Kokai Publication No. JP2003-162355 A
[Patent Document 2] Japanese Patent Kokai Publication No. JP2008-182289A
[Patent Document 3] Japanese Patent Kokai Publication No. JP2003-198685A

### SUMMARY

The entire disclosed contents of the abovementioned Patent Documents 1 to 3 are incorporated herein by reference thereto. The following analysis is given by the present invention. A mobile terminal device described in the abovementioned Patent Document 1 only has one main display screen, and switching of application according to icon selection can only be done on the same screen. In a mobile terminal device that displays two screens at the same time, the screens being foldably connected by a hinge unit, as in the abovementioned Patent Document 2 and Patent Document 3, since a main display screen is provided as two screens, there is an improvement in this point, but an implementation has not been realized in practice. A reason for this may be considered to be difficulties in operability with regard to controlling the two screens with few keys on the mobile terminal device. For example, by a method such as selecting an icon from the main display screen, it is possible to display a new application on a second main display screen. However, according to Patent Document 2 or Patent Document 3, a screen that is a target for operation moves to the second main display screen, and until functions of the second main display screen are ended, it is not possible to perform an operation on the original main display screen. In particular with regard to a mobile terminal device with a small number of keys, it is difficult to provide a key dedicated to switching the screen that is a target for operation. There is no mention in Patent Document 1 also concerning a method of controlling switching of the two screens.

According to a first aspect of the present invention, a mobile terminal device includes: a first main display unit that has a first display screen; a second main display unit that has a second display screen which can display equivalent to the first display screen, and is connected so as to be capable of being juxtaposed to the first main display unit; a display state detection unit that detects whether or not both the first display screen and the second display screen are in a state where simultaneous display is possible; an operation target screen selection unit that executes a function to select, among the first display screen and the second display screen, a screen that is a target for operation; and an operation target screen switching icon display unit that executes a function to display an operation target screen switching icon at least on the screen selected by the operation target screen selection unit, when the display state detection unit detects that both the first display screen and the second display screen are in a state in which display is possible; wherein the operation target screen selection unit switches selection of an operation target screen when the operation target screen switching icon has been selected.

According to a second aspect of the present invention, there is provided a control program for a mobile terminal device, the device including: a first main display unit that has a first display screen; a second main display unit that has a second display screen which can display equivalent to the first display screen, and is connected so as to be capable of being juxtaposed to the first main display unit; a display state detection unit that detects whether or not both the first display screen and the second display screen are in a state where display is possible; and a control unit that performs overall control; the control program executing, on the control unit: a processing, when the display state detection unit detects that a display screen state has changed from a one-screen display state to a state in which display is possible by both the first display screen and the second display screen, of displaying on one of the first display screen or the second display screen a display in which an operation target screen switching icon is added to content displayed in the one-screen display state; and a processing, when a detection is made that the operation target screen switching icon has been selected, of switching a screen that is a target for operation from one of the first display screen or the second display screen to another thereof. The abovementioned control program may be stored in a computer readable storage medium.

According to a third aspect of the present invention, there is provided a multiple display screen control method for a mobile terminal device, the mobile terminal device including: a first main display unit that has a first display screen; a second main display unit that has a second display screen which can display equivalent to the first display screen, and is connected so as to be capable of being juxtaposed to the first main display unit; a display state detection unit that detects whether or not both the first display screen and the second display screen are in a state where display is possible; and an icon selection unit that selects an icon displayed on a display screen; the method being characterized by: displaying on one of the first display screen or the second display screen a display in which an operation target screen switching icon is added to content displayed in a one-screen display state, when the display state detection unit detects that a display screen state has changed from the one-screen display state to a state in which display is possible by both the first display screen and the second display screen; and switching a screen that is a target for operation from one of the first display screen or the second display screen to another thereof, when the operation target screen switching icon is selected by the icon selection unit.

According to the present invention, it is possible to easily perform operation switching for a display screen in a mobile terminal device in which multiple screens can be displayed at the same time.

### BRIEF DESCRIPTION OF THE DRAWINGS

FIG. 1 is a plane view (a two-screen display state, when in use) of a mobile terminal device according to an exemplary embodiment of the present invention;

FIG. 2 is a side view (a folded state, when not in use) of the mobile terminal device according to an exemplary embodiment of the present invention;

FIG. 3 is a plane view (a one-screen display state, when in use) of the mobile terminal device according to an exemplary embodiment of the present invention;

FIG. 4 is a block diagram showing an internal configuration of the mobile terminal device according to an exemplary embodiment of the present invention;

FIG. 5 is a display example (a program listing display in a one-screen display state) of the mobile terminal device according to an exemplary embodiment of the present invention;

FIG. 6 is another display example (a program listing one-screen display in a two-screen display state) of the mobile terminal device according to an exemplary embodiment of the present invention;

FIG. 7 is a further display example (one-segment broadcasting+program listing display in a two-screen display state) of the mobile terminal device according to an exemplary embodiment of the present invention;

FIG. 8 is an even further display example (new mail+information search display in a two-screen display state) of the mobile terminal device according to an exemplary embodiment of the present invention; and

FIG. 9 is an even further display example (new mail+received mail display in a two-screen display state) of the mobile terminal device according to an exemplary embodiment of the present invention.

### PREFERRED MODES

Possible or preferable modes of the present invention are indicated below.

### (Mode 1)

Mode 1 is according to the previously described first aspect.

### (Mode 2)

The second main display unit is preferably connected by a hinge unit or by a slide system with the first main display unit.

### (Mode 3)

An operation unit that has input keys is further provided, wherein the first main display unit and the operation unit are preferably foldably connected by a hinge unit.

### (Mode 4)

The first main display unit and the second main display unit are preferably connected by a hinge unit, the second main display unit comprises a third display screen on a rear side of the second display screen, and, when the display state detection unit detects that the first main display unit and the second main display unit are in a folded state, displays of both the first display screen and the second display screen are stopped, and the third display screen is preferably displayed.

### (Mode 5)

When the display state detection unit detects a change from a folded state to an open state, display content that is displayed on the third display screen is preferably displayed on the second display screen, and the operation target screen switching icon display unit preferably displays the operation target screen switching icon on the second display screen.

### (Mode 6)

The second main display unit is preferably configured to be attachable and detachable relative to the first main display unit.

### (Mode 7)

Mode 7 is according to the previously described second aspect.

### (Mode 8)

In the mobile terminal device configured such that the first main display unit and the second main display unit are folded, with the first display screen and the second display screen facing each other, by a hinge unit, and a third display screen provided on a rear side of the second display screen is exposed on a front face, instead of the first display screen, a program of the mobile terminal device preferably further executes, on the control unit: a processing, when the display state detection unit detects that the first main display unit and the second main display unit are in a folded state, of stopping displaying on the first main display unit and the second main display unit, and of making a display on the third display screen; and a processing, when the display state detection unit detects a change from a folded state to an open state, of displaying, on the second display screen, display content displayed on the third display screen, and also of displaying the operation target screen switching icon on the second display screen.

### (Mode 9)

Mode 9 is according to the previously described third aspect.

### (Mode 10)

In the mobile terminal device configured such that the first main display unit and the second main display unit are folded, with the first display screen and the second display screen facing each other, by a hinge unit, and a third display screen provided on a rear side of the second display screen is exposed on a front face, instead of the first display screen, displaying on the first main display unit and the second main display unit is preferably stopped and a display is made on the third display screen, when the display state detection unit detects that the first main display unit and the second main display unit are in a folded state, and display content displayed on the third display screen is preferably displayed on the second display screen, and the operation target screen switching icon is preferably displayed on the second display screen, when the display state detection unit detects a change from a folded state to an open state.

### (Mode 11)

A computer readable recording medium preferably stores the control program according to the abovementioned Mode 7 or 8.

A supplementary description is given concerning the above-mentioned Mode 1 to Mode 11. It is to be noted that in the supplementary description, reference is made to the drawings as necessary. Furthermore, the drawings and reference symbols in the drawings cited in the supplementary description are shown as an example of exemplary embodiments, and variations of the exemplary embodiments in the present invention are not intended to be limited thereby.

The mobile terminal device in the above modes is provided with a first main display unit that has a first display screen, and a second main display unit that has a second display screen which can provide a display equivalent to the first display screen, and is foldable with respect to the first main display unit. That is, the first main display unit having the first display screen, and the second main display unit having the second display screen are provided, and since the second main display unit is foldable with respect to the first main display unit, it is possible to display double the normal amount of information, without increasing area when folded away.

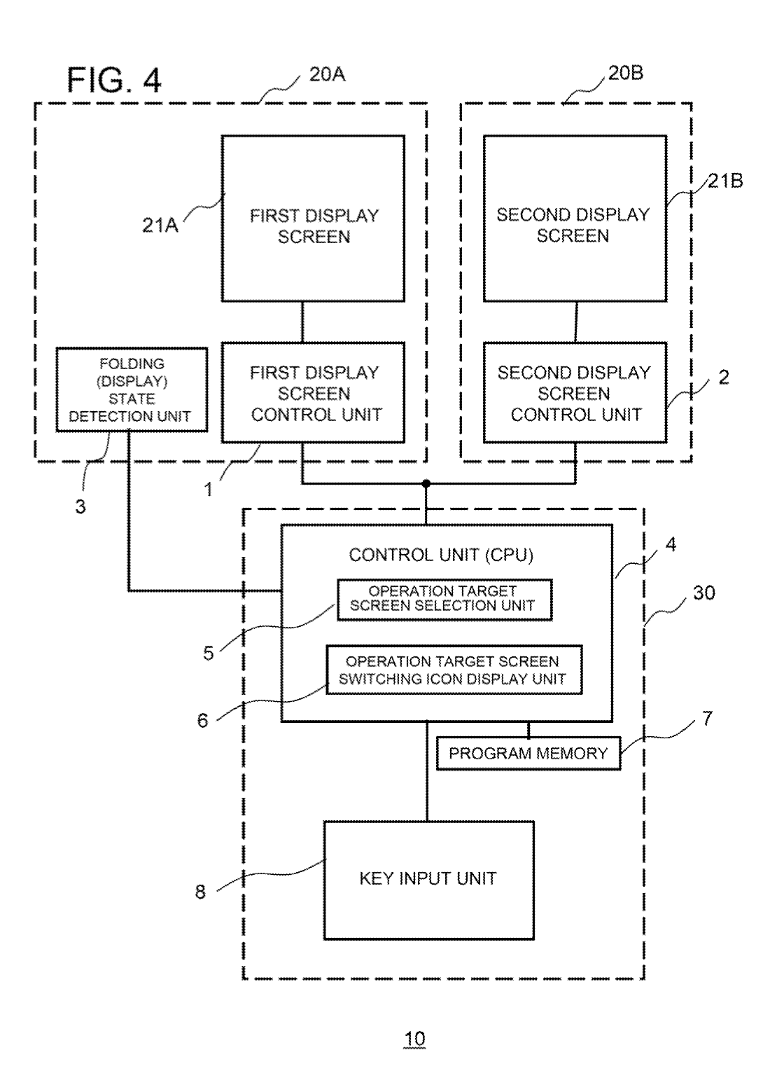

Furthermore, since a folded (display) state detection unit (3 in FIG. 4) that detects whether or not both the first display screen and the second display screen are in a state where simultaneous display is possible, it is possible to automatically judge whether or not a two-screen display is possible, by the folded (display) state detection unit, and to perform an appropriate display.

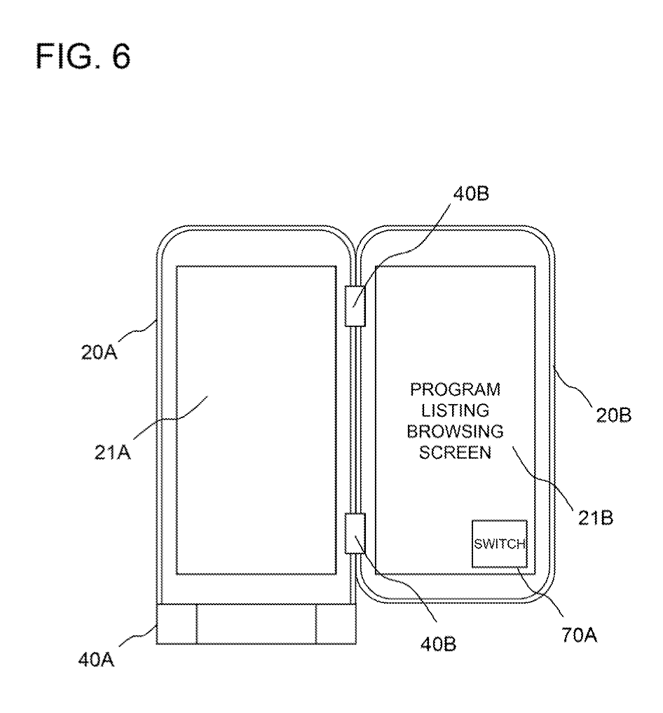

In addition, there are provided: an operation target screen selection unit (5 in FIG. 4) that executes, when the folded (display) state detection unit detects that both the first display screen and the second display screen are in a state where display is possible, a function to select, among the first display screen and the second display screen, a screen that is a target for operation; and an operation target screen switching icon display unit (6 in FIG. 4) that executes a function to display an operation target screen switching icon (70A and 70B in FIG. 6 to FIG. 9) at least on the screen selected by the operation target screen selection unit; wherein the operation target screen selection unit switches selection of the operation target screen when the operation target screen switching icon is selected. That is, when two screens are switchable, it is possible to display the operation target screen switching icon on the screen that is a target for operation, and by selecting the icon, it is possible to switch, among the two screens, the screen that is a target for operation. According to abovementioned configuration, in a mobile terminal device where it is not possible to provide a large number of operation keys, it is possible to easily perform an operation with regard to an application on either screen, among applications on the two screens displayed at the same time.

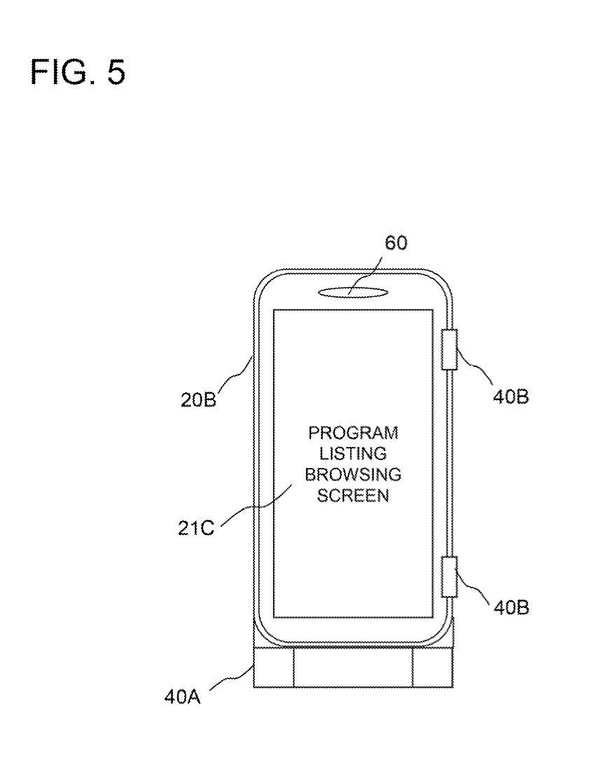

In addition, in particular as shown in FIG. 5 and FIG. 6, the first main display unit (20A) and the second main display unit (20B) are connected by the hinge unit (40B), the second main display unit is provided with a third display screen (21C) on a rear side of the second display screen (21B), and when the folded (display) state detection unit detects that the first main display unit and the second main display unit are in a state of being folded about the hinge unit, displays of both the first display screen and the second display screen are stopped, and the third display screen is displayed (refer to FIG. 5). That is, the present invention is not limited to this configuration, and when the first main display unit and the second main display unit are folded such that the first display screen and the second display screen are facing each other, since both the first display screen and the second display screen can no longer be seen from outside, a display is performed by a third display screen provided on the rear side of the second display screen.

Furthermore, when the folded (display) state detection unit detects a change from a folded state to an open state, display content that is displayed on the third display screen (21C in FIG. 5) is displayed on the second display screen (21 of FIG. 6), and the operation target screen switching icon display unit displays the operation target screen switching icon on the second display screen.

In addition, if the mobile terminal device of the above-mentioned modes is at least provided with a control unit (4 in FIG. 4) that controls functional operation of the mobile terminal device, switching of the screen that is an operation target is possible by the control program.

Furthermore, according to a multiple display screen control method of the mobile terminal device of the abovementioned modes, if the mobile terminal device is provided with an icon selection unit for selecting an icon displayed on a display screen, it is possible to display the operation target screen switching icon on the screen, and by selection of the icon displayed thereon by the icon selection unit, it is possible to switch the screen that is a target for operation, from among the displayed screens. Detailed description is given below concerning exemplary embodiments, making reference to the drawings.

### Exemplary Embodiment 1

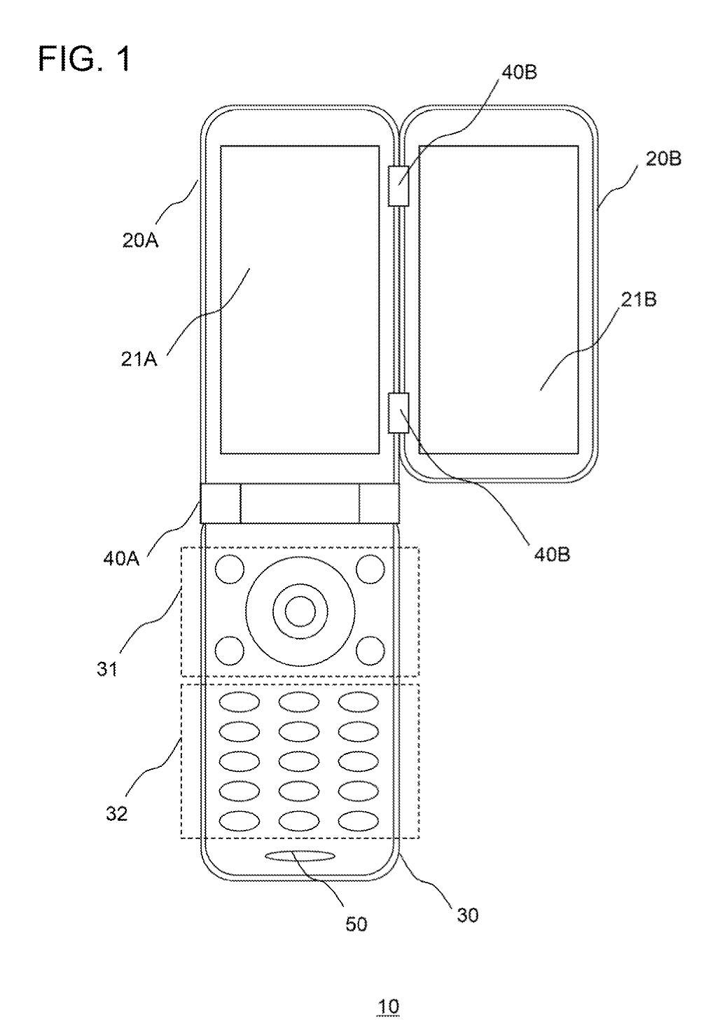

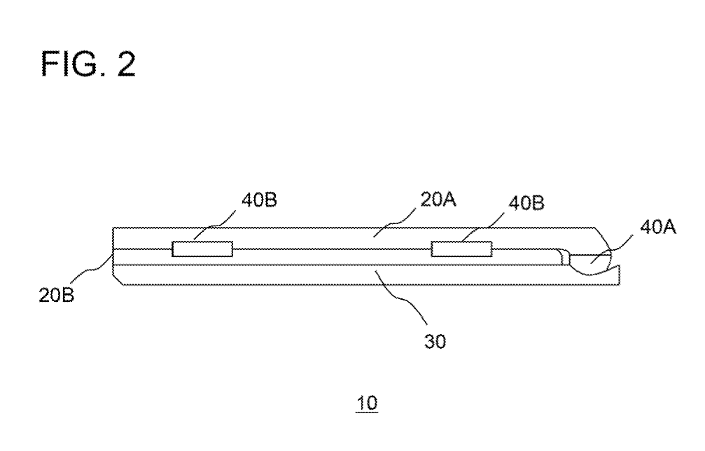

FIG. 1 to FIG. 3 are drawings showing external views of a mobile terminal device of the present exemplary embodiment. In FIG. 1, the mobile terminal device 10 has what is called a folding type of configuration in which a first main display unit 20A having a display function that is a main display, and an operation unit 30 having operation keys 31 to execute selection and determination of a screen, and input keys 32 as in a numeric keypad or the like to perform key input, are connected to one another via a hinge unit 40A. FIG. 1 shows a state where the mobile terminal device 10 is in use (the terminal is opened), and FIG. 2 shows a state where the mobile terminal device 10 is not in use (the terminal is closed).

The first main display unit 20A in FIG. 1 and a second main display unit 20B are connected to one another via a hinge unit 40B, and the second main display unit 20B is opened and closed relative to the first main display unit 20A by rotating the second main display unit 20B with the hinge unit 40B as pivot axis. A first display screen 21A and a second display screen 21B, in which various applications are displayed, are respectively disposed in the first main display unit 20A and the second main display unit 20B, and a microphone 50, in addition to the operation keys 31 and the input keys 32 are disposed in the operation unit 30. Furthermore, a folded (display) state detection unit (3 in FIG. 4, to be described later), which is a sensor that responds according to an open-close angle of the second main display unit 20B, for example, is built in, inside the first main display unit 20A.

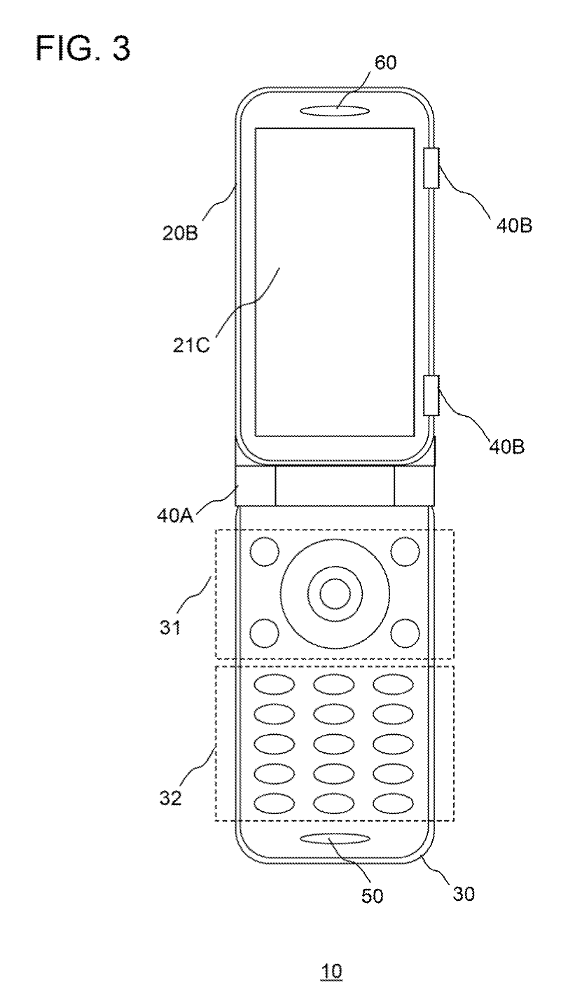

FIG. 3 is an external view of the mobile terminal device 10 with only the second main display unit 20B of the main terminal closed. In this drawing, the second main display unit 20B has a third display screen 21C and a speaker for conversation (receiver) 60 provided on a rear side of the second display screen 21B, and usage by a user is possible with the second main display unit 20B superimposed on the first main display unit 20A, without difference from a conventional folding type mobile terminal device having only one display unit. That is, the second display screen 21B and the third display screen 21C are provided respectively on the front and rear of the second main display unit 20B. With regard to switching of the screen displays of the front and rear display regions, the folded (display) state detection unit (3 in FIG. 4, to be described later), which is a sensor built into the first main display unit 20A, detects an open-close angle of the second main display unit 20B, and switching takes place automatically.

FIG. 4 is a block diagram showing an internal configuration of the mobile terminal device 10 according to the present exemplary embodiment. The mobile terminal device 10, broadly divided, is configured by the first main display unit 20A, the second main display unit 20B, and the operation unit 30.

The first main display unit 20A is provided with the first display screen 21A, a first display screen control unit 1 that directly controls the first display screen 21A, and the folded (display) state detection unit 3. The folded (display) state detection unit 3 outputs, as a folded (display) state detection signal, whether the first main display unit 20A and the second main display unit 20B are open, with the hinge unit 40B as an axis, so that a simultaneous display is possible on screens of both the first display screen 21A and the second display screen 21B, or whether the first main display unit 20A and the second main display unit 20B are folded about the hinge unit 40B, and even with a simultaneous display, the state is such that the user cannot perform visual confirmation thereof.

Furthermore, the second main display unit 20B is provided with the second display screen 21B and a second display screen control unit 2 that directly controls the second display screen 21B.

The control unit 30 is provided with the control unit (CPU) 4, a key input unit 8, and in addition, a program memory 7. The operation keys 31 and the input keys 32, described in FIG. 1 and FIG. 3, are connected to the key input unit 8, and information inputted from the keys is transmitted to the control unit 4. The control unit 4 functions as an operation target screen selection unit 5 and an operation target screen switching icon display unit 6, by a program stored in the program memory 7.

The operation target screen selection unit 5 has a switching function with regard to which display screen, among the two screens, key input that has been inputted from the key input unit 8 is directed towards, in a case where the folded (display) state detection unit 3 detects that both the first display screen 21A and the second display screen 21B are in a state where simultaneous display is possible. Based on information (a process) of the operation target screen selection unit 5 and the key by which input was performed from the key input unit 8, the control unit 4 performs an operation with respect to an application displayed on one among the two screens, and gives an instruction to the first display screen control unit 1 or the second display screen control unit 2 to display a result thereof on a corresponding screen. Furthermore, in a case where the operation target screen switching icon (70A, 70B in FIG. 6 to FIG. 9) is selected by a signal from the key input unit 8, the operation target screen selection unit 5 performs switching, among the two screens displayed at the same time, of a screen that is a target for key operation thereafter. Since switching is performed with respect to the screen that is a target for operation by the operation target screen selection unit 5, the user can perform an operation with regard to the screen that is a target for operation the same as with a normal one-screen display.

In a case where the two screen displays are possible, the operation target screen switching icon display unit 6 controls the first display screen control unit 1 or the second display screen control unit 2 so as to display the operation target screen switching icon on a screen that has become a target for operation according to the operation target screen selection unit 5. It is to be noted that with regard to the operation target screen switching icon, a display may be left on the screen that is not a target for operation. Since the operation target screen switching icon is displayed on the screen that is a target for operation by the operation target screen switching icon display unit 6, the user can easily switch the screen that is a target for operation, among the two screen displays. That is, with multiple screens open at the same time the user can perform an operation on any screen, by the operation target screen selection unit 5 and the operation target screen switching icon display unit 6.

It is to be noted that in FIG. 4, the first display screen control unit 1 and the second display screen control unit 2 are separated from the control unit 4, but functions of the first display screen control unit 1 and the second display screen control unit 2 may be given to the control unit 4. Furthermore, in FIG. 4, the first display screen control unit 1 and the folded (display) state detection unit 3 are provided in the first main display unit 20A, the second display screen control unit 2 is provided in the second main display unit 20B, and the control unit 4 is provided in the operation unit 30, but the first display screen control unit 1, the second display screen control unit 2, the folded (display) state detection unit 3, and the control unit 4 may be provided anywhere in the first main display unit 20A, the second main display unit 20B, and the control unit 30.

Next, a description is given of a series of operations that can be realized by the present exemplary embodiment, using FIG. 5 to FIG. 9. In FIG. 5 to FIG. 9, as an operation in a preferred exemplary embodiment, switching occurs when the user executes a prescribed operation, and applications are shown that are displayed respectively in the first display screen 21A, the second display screen 21B, and the third display screen 21C, of the first main display unit 20A and the second main display unit 20B.

First, as in FIG. 5 the user starts up a browser and browses a program listing. While browsing, since the user finds a program in the program listing that he or she wishes to see, by rotating the second main display unit 20B with the hinge unit 40B as pivot axis, the user can switch the program listing screen of the browser, by the folded (display) state detection unit 3 (for example, an angle detection sensor), from the third display screen 21C to the second display screen 21B (FIG. 6). At this time, the operation target screen switching icon 70A, to be selected when switching an operation target screen, is newly generated within the second display screen 21B.

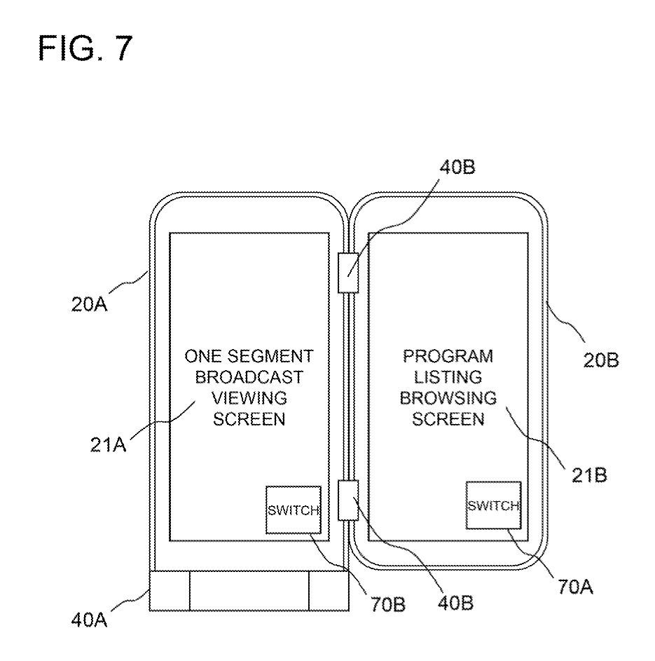

Next, with a prescribed operation, that is, by using the operation keys 31, a cursor is moved to the operation target screen switching icon 70A in the second display screen 21B, and a selection is made to determine screen switching. In addition, after switching the operation target screen to the first display screen 21A, one segment broadcasting (one segment reception service, such as terrestrial digital television broadcasting targeted at mobile terminal devices such as cell phones and the like) is started up on the first display screen 21A, and while browsing the program listing on the second display screen 21B and confirming a program displayed on the first display screen 21A, the screen is switched to a desired channel (FIG. 7). Here, when the operation target screen is switched from the second display screen 21B to the first display screen 21A, an operation target screen switching icon 70B is newly generated within the first display screen 21A. It is to be noted that, as an operation when a window with no application started up is activated, a setting is necessary such that a prescribed default screen (for example, a standby screen) is displayed, but there is no special stimulation in this regard. It is possible to display an arbitrary screen. If an application is started up, it is possible to continue with an operation target screen as is.

At this time, a one segment viewing screen is shown on the first display screen 21A, and a program is displayed by a browser on the second display screen 21B (FIG. 7). Here, for example, it is possible to select the operation target screen switching icon 70B on the first display screen 21A, move the operation target screen to the second display screen 21B where the program listing is re-displayed, and continue browsing. If it is desired to view another broadcast, it is possible to move operation to the one segment viewing screen again by a similar procedure.

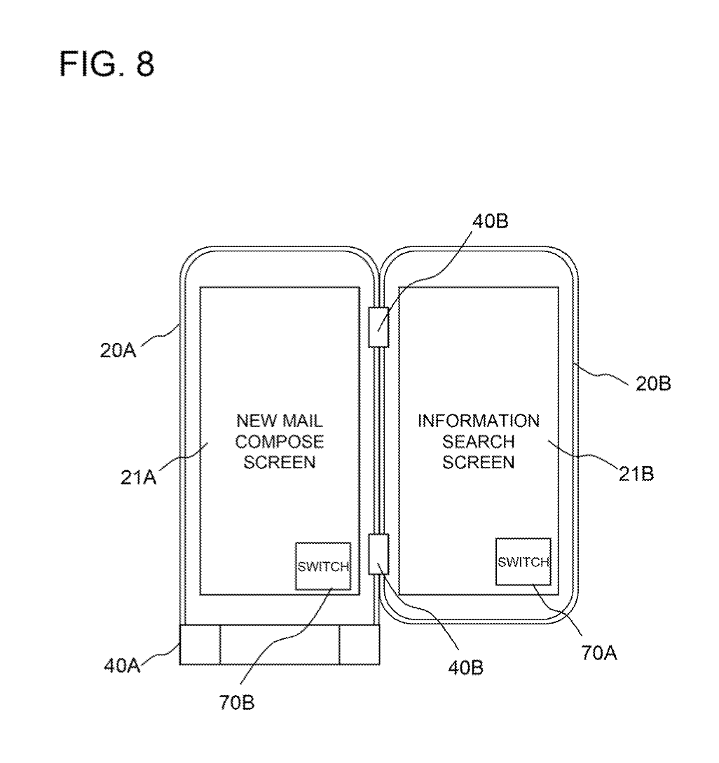

Next, information of interest in a program being viewed is obtained, and in order to investigate in more depth concerning this information, a URL of an information search site is inputted in the program listing screen of the second display screen 21B, or if there is a link in this screen, the second display screen 21B is switched to a search screen by selecting this link, and a search is executed. In a case where this information is noted in a mail and transmitted to a friend, in the same way as described above, the operation target screen switching icon 70A in the second display screen 21B is selected, a mailer is started up in the first display screen 21A, and composition of text is performed. At this time also, composition of the mail can be carried out while viewing a search result in the browser (FIG. 8).

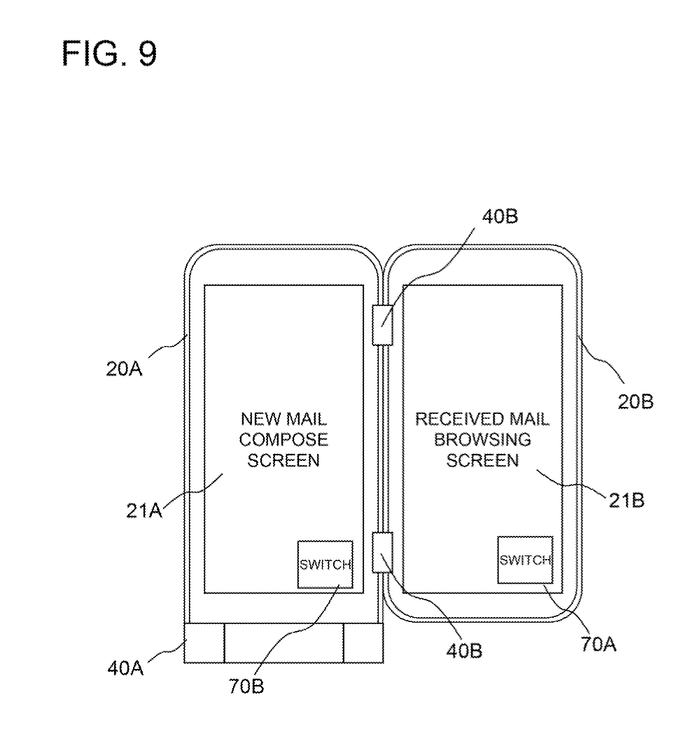

In addition, while browsing the content of a received mail transmitted previously by the friend, a portion is extracted and added to the mail being composed. In this case also, in the same way, first the operation target screen switching icon 70B that is in the first display screen 21A is selected, and the content of the received mail is displayed in the second display screen 21B. Thereafter, while browsing the two screens in parallel, a place that is desired to be extracted from the reference mail of the second display screen 21B is copied as necessary and pasted to the mail being composed in the first display screen 21A. By appropriately selecting the operation target screen switching icons 70A and 70B, the above type of task is executed while switching screens (FIG. 9).

In other cases also, according to the present invention, since related applications are displayed on two screens, and with regard to either of the screens, a screen that is a target of operation can be easily switched to perform operations in parallel, many combinations of useful applications can be considered. One example thereof is shown in Table 1.

TABLE 1

| Display Screen (1) | Display Screen (2) | Effect |
|---|---|---|
| One segment | Browser (program | Possible to switch channel |
| broadcasting | listing) | while browsing program |
| | | content in the program |
| | | listing. |
| Mailer | Browser | Possible to compose mail |
| (compose text) | (information search) | while browsing/confirming |
| | | information obtained by |
| | | search. |
| Mailer | Mailer (send/receive | Possible to compose mail |
| (compose text) | mail) | while browsing/confirming |
| | | transmitted and received |
| | | mail. Extraction is easy by |
| | | copying and pasting. |
| Telephone directory | Browser | (Example) In a case of |
| (edit) | (information search) | registering a favorite store, |
| | | possible to register while |
| | | confirming information |
| | | displayed in a search result. |
| Telephone directory | Mailer (send/receive | In a case of registering a |
| (edit) | mail) | new acquaintance, possible |
| | | to register while confirming |
| | | name and other information |
| | | described in mail text. |
| Function setting | Various types of | Possible to make changes |
| | applications | while instantly confirming |
| | | function setting |
| Schedule (edit) | Schedule (listing) | Possible to adjust future |
| | | schedule while confirming |
| | | near future appointments |
| Music player | Melody (voice) | In a case of recording only a |
| | recording | portion of the music (voice), |
| | | possible to record at good |
| | | timing while confirming |
| | | progress status and time |
| One segment | Melody (voice) | In a case of recording only a |
| broadcasting | recording | portion of the music (voice), |
| | | possible to record at good |
| | | timing while viewing a |
| | | screen (effectively avoiding |
| | | unnecessary recording (CM |
| | | and the like)) |
| One segment | Movie | Possible to simultaneously |
| broadcasting | | view two screens, one |
| | | segment broadcasting and |
| | | video stored as data |
| Game | Browser | Possible to play a game |
| | (information search) | while browsing a method of |
| | | attack displayed in a search |
| | | result |

It is to be noted that the abovementioned display screen (1) and the display screen (2) can be displayed on either of the first display screen 21A and the second display screen 21B.

It is to be noted that in the abovementioned exemplary embodiment, the second main display unit 20B is foldably connected to the first main display unit 20A by the hinge unit 40B, but the second main display unit 20B may be connected to the first main display unit 20A by a slide system (mechanism) instead of the hinge unit 40B.

Furthermore, a configuration is also possible in which the second main display unit 20B is attachable and detachable relative to the first main display unit 20A.

Descriptions concerning the exemplary embodiments have been given above but the present invention is not limited to only configurations of the abovementioned exemplary embodiments, and clearly includes every type of transformation and modification that a person skilled in the art can realize within the bounds of the invention. That is, modifications and adjustments of embodiments and examples are possible within the bounds of the entire disclosure (including the scope of the claims) of the present invention, and also based on fundamental technological concepts thereof. Furthermore, a wide variety of combinations and selections of various disclosed elements is possible within the scope of the claims of the present invention.

### EXPLANATIONS OF SYMBOLS

1 first display screen control unit
2 second display screen control unit
3 folding (display) state detection unit
4 control unit (CPU)
5 operation target screen selection unit
6 operation target screen switching icon display unit
7 program memory
8 key input unit
10 mobile terminal device
20A first main display unit
20B second main display unit
21A first display screen
21B second display screen
21C third display screen
30 operation unit
31 operation keys
32 input keys
40A, 40B hinge unit
50 microphone
60 speaker for conversation (receiver)
70A, 70B operation target screen switching icon

What is claimed is:

1. A mobile terminal device, comprising
a first main display unit that has a first display screen;
a second main display unit that has a second display screen which can display equivalent to said first display screen, said second main display unit being connected so as to be capable of being juxtaposed to said first main display unit;
a display state detection unit that detects whether or not both said first display screen and said second display screen are in a state where simultaneous display is possible;
an operation target screen selection unit that executes a function to select, among said first display screen and said second display screen, a screen that is a target for operation; and
an operation target screen switching icon display unit that executes a function to display an operation target screen switching icon at least on the screen selected by said operation target screen selection unit, when said display state detection unit detects that both said first display screen and said second display screen are in a state in which display is possible; wherein
said operation target screen selection unit switches selection of an operation target screen when said operation target screen switching icon is selected.

2. The mobile terminal device according to claim 1, wherein said second main display unit is connected by a hinge unit or by a slide system with said first main display unit.

3. The mobile terminal device according to claim 1, characterized by further comprising an operation unit that has input keys, wherein said first main display unit and said operation unit are foldably connected by a hinge unit.

4. The mobile terminal device according to claim 1, wherein said first main display unit and said second main display unit are connected by a hinge unit, and said second main display unit comprises a third display screen on a rear side of said second display screen, wherein,
when said display state detection unit detects that said first main display unit and said second main display unit are in a folded state, displays of both said first display screen and said second display screen are stopped, and said third display screen is displayed.

5. The mobile terminal device according to claim 4, wherein, when said display state detection unit detects a change from a folded state to an open state, display content that is displayed on said third display screen is displayed on said second display screen, and said operation target screen switching icon display unit displays said operation target screen switching icon on said second display screen.

6. The mobile terminal device according to claim 1, wherein said second main display unit is configured to be attachable and detachable relative to said first main display unit.

7. A control program for a mobile terminal device, said device comprising:
a first main display unit that has a first display screen;
a second main display unit that has a second display screen which can display equivalent to said first display screen, said second main display unit being connected so as to be capable of being juxtaposed to said first main display unit;
a display state detection unit that detects whether or not both said first display screen and said second display screen are in a state where display is possible; and
a control unit that performs overall control;
said control program being characterized by executing, on said control unit:
a processing, when said display state detection unit detects that a display screen state has changed from a one-screen display state to a state in which display is possible by both said first display screen and said second display screen, of displaying on one of said first display screen or said second display screen a display in which an operation target screen switching icon is added to content displayed in said one-screen display state; and
a processing, when a detection is made that said operation target screen switching icon has been selected, of switching a screen that is a target for operation from one of said first display screen or said second display screen to another thereof.

8. The control program for a mobile terminal device, according to claim 7, said mobile terminal device being configured such that said first main display unit and said second main display unit are folded, with said first display screen and said second display screen facing each other, by a hinge unit, and a third display screen provided on a rear side of said second display screen is exposed on a front face, instead of said first display screen,
said control program further executing, in said control unit:
a processing, when said display state detection unit detects that said first main display unit and said second main display unit are in a folded state, of stopping displaying on said first main display unit and said second main display unit, and performing display by said third display screen; and
a processing, when said display state detection unit detects a change from a folded state to an open state, of displaying, on said second display screen, display content displayed on said third display screen, and also displaying said operation target screen switching icon on said second display screen.

9. A multiple display screen control method for a mobile terminal device, said mobile terminal device comprising:
a first main display unit that has a first display screen;
a second main display unit that has a second display screen which can display equivalent to said first display screen, said second main display unit being connected so as to be capable of being juxtaposed to said first main display unit;
a display state detection unit that detects whether or not both said first display screen and said second display screen are in a state where display is possible; and
an icon selection unit that selects an icon displayed on a display screen;
said method comprising:
displaying on one of said first display screen or said second display screen a display in which an operation target screen switching icon is added to content displayed in a one-screen display state, when said display state detection unit detects that a display screen state has changed from said one-screen display state to a state in which display is possible by both said first display screen and said second display screen; and
switching a screen that is a target for operation from one of said first display screen or said second display screen to another thereof, when said operation target screen switching icon is selected by said icon selection unit.

10. The multiple display screen control method for a mobile terminal device, according to claim 9, wherein said mobile terminal device is configured such that said first main display unit and said second main display unit are folded, with said first display screen and said second display screen facing each other, by a hinge unit, and a third display screen provided on a rear side of said second display screen is exposed on a front face, instead of said first display screen,
said method comprising:
stopping displaying on said first main display unit and said second main display unit and displaying by said third display screen, when said display state detection unit detects that said first main display unit and said second main display unit are in a folded state; and
displaying, on said second display screen, display content displayed on said third display screen, and also displaying said operation target screen switching icon on said second display screen, when said display state detection unit detects a change from a folded state to an open state.

11. A computer readable recording medium that stores said control program according to claim 7.
